(19) United States
(12) Patent Application Publication
(10) Pub. No.: US 2007/0210640 A1
(43) Pub. Date: Sep. 13, 2007

(54) Hub cap

(76) Inventor: Dennis Roger Rogers, Ormond Beach, FL (US)

Correspondence Address: DINSMORE & SHOHL LLP;One Dayton Centre, Suite 1300, One South Main Street, Dayton, OH, 45402-2023, US

(21) Appl. No.: 11/369,469

(22) Filed: Mar. 7, 2006

(51) Int. Cl. B60B 7/14

(52) U.S. Cl. 301/37.373

(57) ABSTRACT

A hub cap for a vehicular wheel. The hub cap includes a body portion and a wheel coupling portion, both made from a non-metallic material. The wheel coupling portion has circumferentially-spaced lug nut engaging members that are axially alignable with lug nuts extending from the wheel. The lug nut engaging members form a substantially arcuate shape, and are resiliently biased so that upon placement of the hub cap onto a wheel, the lug nuts push the lug nut engaging members in a radial direction. Continued contact between the lug nuts and their corresponding engaging members promotes secure connection between the hub cap and wheel. In one embodiment, the body portion and wheel engaging portion is formed from two separate pieces that are subsequently joined, while in another, they are formed from a single unitary structure to define a one-piece construction.

### BACKGROUND OF THE INVENTION

This invention relates generally to a vehicular hub cap, and more particularly to attachment features formed in a hub cap to enhance attachment integrity under harsh environmental conditions.

Decorative wheel covers form an important part of a vehicle's appeal, and can be used to cover portions or all of an outward-facing surface of a vehicular wheel. Such covers allow conventional fabricated steel wheels to emulate the aesthetically-pleasing attributes of polished, chrome-plated or cast aluminum wheels at a small fraction of the cost. Most wheels for such applications include a rim section, a spoke (or web) section and a central hub section, the latter of which allows for connection between the wheel and an axle. The hub section is one area of the wheel's outward-facing surface that can especially benefit from decorative covers, as otherwise unsightly lugs, lug nuts and axle spindles are left exposed. Wheel covers that overlie the hub section are often referred to as hub caps.

Increasingly, hub caps are made from inexpensive, lightweight, non-metallic materials (for example, plastic) that are easily formable, impact-resistant, and (with the placement of an appropriate metallized coating on a surface thereof) capable of providing a desirable level of metallic finish and luster. In another form, hub caps could have the color molded-in, or coated with a secondary finish, such as paint or the aforementioned metallized finish. While the use of highly decorative hub caps is in its ascendancy, difficulties in reliably and inexpensively securing these hub caps to the underlying wheel or lug nuts used to secure the wheel to an axle jeopardize their long-term viability. Fasteners, such as resilient snap-fit extensions on the back (inward-facing) surface of the cover, can be employed to keep the cover affixed to the wheel to withstand the sort of rotational and vibration loading typically encountered in a vehicular environment. Often, these snap-fit fasteners are integrally formed (i.e., unitary, or one-piece) with the wheel cover. Other resilient fasteners, forming a friction-fit rather than a snap-fit, have also been used. In an alternative to snap-fit and friction-fit fasteners, high-strength adhesives have also been used. The use of such adhesives, while potentially beneficial for thermal protection of, and acoustic enhancement to, wheel covers, necessitates relatively detailed placement and assembly procedures to ensure weight minimization, adequate affixation and dynamic balancing, with concomitant increases in manufacturing costs. As such, the use of the aforementioned resiliently-biased snap-fit and friction-fit fasteners has enjoyed a prominent place in the wheel cover market.

Nevertheless, the fasteners, which are typically in the form of cantilevered, tubular cups with segmented, finger-like extensions formed on the inner surface of the hub cap can soften, creep or otherwise suffer reduced grip on the lug nuts as a result of high temperature and rotational loads. These conditions result from wheel rotation and braking. For example, braking in loaded trucks can produce temperatures in the lugs and lug nuts of up to 400 degrees Fahrenheit, a temperature that would soften (if not outright destroy) many conventional plastic materials. Furthermore, differences in the rate of thermal expansion of the metallic wheel and the plastic hub cap can exacerbate an already loose or weakened fastener connection. In addition, individual fingers within the fasteners may be susceptible to breakage due to improper alignment, mounting and handling. Other approaches may employ multi-piece construction with metallic fasteners. While such a construction may have the advantage of better resistance to the buildup of heat, it does so with increases in weight and cost through the use of stamped metal parts that may require coating or related environmental protection to avoid the effects of rust or related corrosion. Moreover, schemes to attach the fasteners to the hub cap may be susceptible to heat or vibration-induced wear and subsequent separation, as friction-fit connections can work their way loose over extended periods of operation.

What is needed is a way to secure a hub cap to a wheel inexpensively and reliably under all of the conditions normally encountered in a vehicular environment. Also desired is a hub cap that can satisfy the above needs without using metal-based structural components.

### SUMMARY OF THE INVENTION

These needs are met by the present invention, where a hub cap can be affixed to a wheel to ensure a durable, robust connection between the two. In a first aspect of the invention, the hub cap includes a non-metallic body portion defining an inner (inward-facing) surface and an outer (viewable) surface, and a non-metallic wheel coupling portion extending from the inner surface of the body portion. In the present context, the term “non-metallic” and its variants is used to define the material makeup of the main structural attributes of the body portion and the wheel coupling portion. The incidental use of metal for chiefly aesthetic reasons, such as the placement of a metallized coating to give a chrome or related glossy finish on the surface of the body portion, is not inconsistent with such coated portion being construed as non-metallic. The wheel coupling portion comprises a plurality of resiliently biased, lug nut engaging members disposed about the periphery of the body portion and axially alignable with lug nuts disposed on a wheel.

The resiliently biased configuration of the lug nut engaging members may be due to, for example, a cantilevered construction of the members relative to the body. By engaging the lug nut, the lug nut engaging members radially deflect to an extent necessary to cooperate with one another to keep the hub cap attached to the wheel. Each of the lug nut engaging members includes a substantially arcuate base configured to engage axially at least one surface of the lug nut, and a substantially arcuate crown axially aligned with and disposed axially inward relative to the substantially arcuate horizontal base. Inherent in an arcuate structure is the partial, bow-like contact area with the device it surrounds. By having only a portion of the circumference of a lug nut engaged rather than substantially full circular contact area, the present lug nut engaging members provide more assembly tolerance, as well as reduced susceptibility to member breakage. In the present context, the term “substantially” is utilized to represent the inherent degree of uncertainty that may be attributed to any quantitative comparison, value, measurement, or other representation. As such, it refers to an arrangement of elements or features that, while in theory would be expected to exhibit exact correspondence or behavior, may in practice embody something slightly less than exact. The term also represents the degree by which a quantitative representation may vary from a stated reference without resulting in a change in the basic function of the subject matter at issue.

Optionally, the lug nut engaging members include numerous anti-rotation standoffs disposed about the base. These standoffs may, for example, include generally planar surfaces that can be placed against the faceted outward surfaces of a standard hexagonal-shaped lug nut to inhibit nut rotation. The lug nut engaging members may include an axial stiffening rib to enhance flexural resistance. Such flexure (i.e., radial deflection) of the members may be caused by, among other things, contact with the lug nuts, high rotational (centrifugal) loading or the like. The crown may define a castellated structure, which may include beveling to promote ease of insertion with a corresponding lug nut. In a particular form, the base and crown define a radially outward portion of each of the lug nut engaging members. A retaining wire may be disposed on this radially outward-facing surface of the lug nut engaging members. This wire can be made from a variety of structural, relatively temperature-resistant materials, including ceramics (including fiber-reinforced ceramic composites), high temperature plastics or metal. Furthermore, a series of brackets may be formed in the inner surface of the hub cap body portion to allow a secure fit of the wire.

In one variant of the hub cap design, the lug nut engaging members can be integrally formed with the body portion to define a one-piece hub cap design. In another variant, the lug nut engaging members are integrally formed with one another on a common ring, which in turn can be removably attachable to the body portion, thereby resulting in a two-piece hub cap design. In this latter configuration, a boss can be formed on the inner surface of the hub cap body portion. The boss can define an aperture therein to allow passage of projecting connectors (also referred to as projections) situated on the ring. In one form, the projections are resiliently-biased snap-fit detents that are integrally formed in the ring. At least one of the ring and the hub cap can be made from a plastic, ceramic or continuous or discontinuous reinforced composite based on plastic or ceramic. In situations where excessive heat soaking may be experienced, the ring can be molded from a separate, higher-temperature plastic, ceramic or composite material, such as a glass-reinforced nylon. To enhance the outward appearance of the hub cap, a metallic (for example, chrome or chrome-like) coating may be used in the body portion. In another form, colors may be painted onto or molded in the body portion to enhance its appearance.

In the one-piece variant of the hub cap, the lug nut engaging members form a substantially cantilevered attachment to the body portion. In this way, the base forms a proximal end (i.e., closest to the point of connection between the body portion and the lug nut engaging members), while the crown defines a distal end. The inherent flexibility in a cantilever structure allows the distal portion adjacent the crown to move radially relative to the proximal end and the body portion. As with the two-piece variant discussed above, plastic, ceramic or composite materials may be used. Also as with the two-piece variant discussed above, the outward appearance of the hub cap can be augmented by the addition of a metallic coating, painted-on coating or through molded-in color.

According to another aspect of the invention, a hub cap, comprising a body portion and a wheel coupling portion, is disclosed. The body portion defines an inner surface and an outer surface. The inner surface comprises a boss with an aperture that allows the wheel coupling portion to be removably attachable. The wheel coupling portion includes a ring, numerous circumferentially spaced and resiliently biased lug nut engaging members disposed on the ring, and a plurality of projections disposed on the ring. The projections are oriented to engage the boss aperture to facilitate connection between the wheel coupling portion and the body portion. The lug nut engaging members extend axially inward and are alignable with corresponding lug nuts disposed on a wheel. Each of these members includes a proximal end, defining a base configured to engage axially a corresponding one of the lug nuts, and a distal end, defining a substantially arcuate crown axially aligned with, and disposed axially inward relative to, the base. In this way, radial deflections imparted to each of the crowns by the lug nuts promote a secure connection between the hub cap and the wheel.

Optionally, the projections comprise snap-fit detents. The snap-fit detents preferably define an angled distal portion. Likewise, the boss aperture defines a beveled surface to facilitate the insertion of the angled distal portion of snap-fit detents. As stated in conjunction with an earlier aspect, the lug nut engaging members and the projections can be integrally formed with the ring, where the ring, lug nut engaging members and projections can be made from a temperature-resistant, non-metallic material.

According to another aspect of the invention, a wheel assembly includes a wheel and a hub cap configured to cover at least a portion of the wheel. The hub cap includes a body portion defining an inner surface and an outer surface, and a wheel coupling portion extending from the inner surface of the body portion. The wheel coupling portion comprises a plurality of circumferentially spaced and resiliently biased lug nut engaging members that are axially alignable with corresponding lug nuts. The lug nut engaging members are configured to secure the wheel to a vehicle. Each of the lug nut engaging members includes a substantially arcuate base configured to engage axially a corresponding one of the lug nuts, and a substantially arcuate crown, axially aligned with and disposed axially inward relative to the base. As before, radial deflections imparted to each of the lug nut engaging members cause them to cooperate with the lug nuts, thereby keeping the hub cap attached to the wheel.

Optionally, the lug nut engaging members can be either integrally formed with the body portion to define a one-piece structure, or can be integrally formed with one another on a common ring. In this latter (two-piece) configuration, the ring includes numerous snap-fit detents that make the ring removably attachable to the body portion by engaging the snap-fit detents through an aperture defined in a boss formed on the inner surface.

According to still another aspect of the invention, a method of covering a vehicular wheel is disclosed, where the wheel includes an inner surface, an outer surface and a plurality of lug nuts protruding substantially outward from the outer surface. It will be appreciated that the wheel outer surface is that which is viewable by an observer standing away from the vehicle when the wheel is mounted onto the vehicle. The method includes providing a wheel and a hub cap and securing the hub cap to the wheel such that lug nuts used to secure the wheel to an axle or other part of a vehicle impart a radial deflection to corresponding lug nut engaging members, thereby causing them to keep the hub cap attached to the wheel. As before, the hub cap includes a body portion and a wheel coupling portion extending from an inner surface of the body portion. The wheel coupling portion includes numerous circumferentially spaced and resiliently biased lug nut engaging members. Each of the lug nut engaging members includes a base to engage axially one of the lug nuts, and a substantially arcuate crown axially aligned with and disposed axially inward relative to the base.

Optionally, the method includes configuring the wheel coupling portion as a ring with extending lug nut engaging members, and creating a snap-fit connection between the ring and the body portion to facilitate removable attachment between the ring and body portion. At least one of the body portion and the ring may be made from the aforementioned ceramic, plastic or composite based on either or both. As previously discussed, the method may include reinforcing the lug nut engaging members with a retaining wire.

### BRIEF DESCRIPTION OF THE DRAWINGS

FIG. 1 is an exploded front view of a wheel assembly showing its attachment to a vehicle according to a first aspect of the present invention;

FIG. 2 is a rear cutaway view of a hub cap of the wheel assembly of FIG. 1, showing both hub cap body portion and wheel coupling portion in the form of a ring;

FIG. 3 is a rear view of the hub cap of FIG. 2 with the ring removed;

FIG. 4 is a front view of the ring of FIG. 2 with lug nut engaging members;

FIG. 5 is a rear view of the ring of FIG. 4;

FIG. 6 is a cutaway view of the hub cap of FIG. 2 secured to the lug nuts of a portion of an automotive wheel;

FIG. 7 is a rear cutaway view of a hub cap according to a second aspect of the present invention;

FIG. 8 is rear cutaway view of the hub cap of FIG. 7, with a retaining wire disposed around the outer periphery of a lug nut engaging member that is integrally formed with the hub cap;

FIG. 9A is a radially inward-looking view showing a variation on the ring of FIGS. 4 and 5 with an alternate connection scheme between the ring's lug nut engaging member and a retaining wire;

FIG. 9B is a radially outward-looking view of the lug nut engaging member and the retaining wire of FIG. 9A;

FIG. 10 shows the lug nut engaging member and the retaining wire of FIG. 9A over a larger portion of the ring, illustrating alternating wire attachment locations; and

FIG. 11 shows a retaining wire retention scheme that differs from of FIGS. 9A, 9B and 10.

### DETAILED DESCRIPTION OF THE PREFERRED EMBODIMENTS

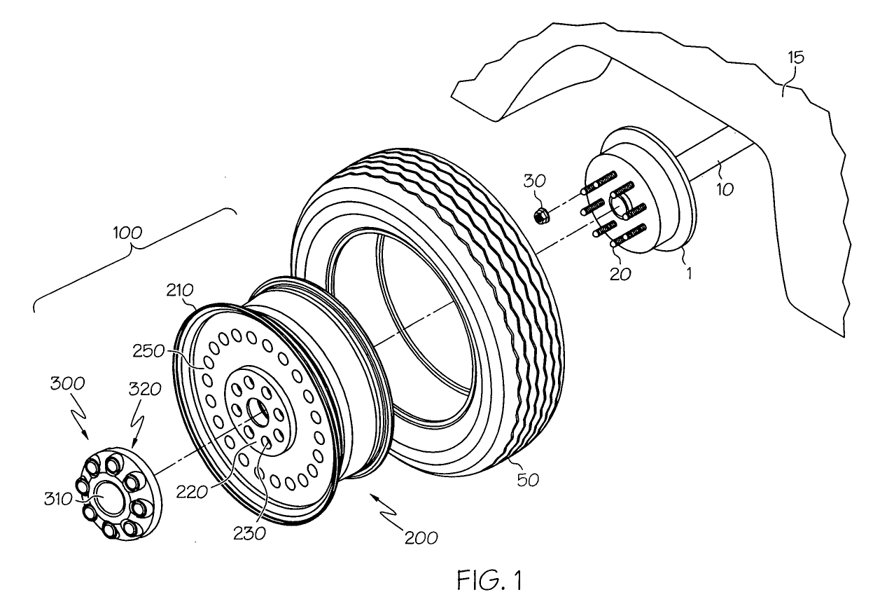

FIG. 1 is an outward-facing exploded view of a wheel assembly 100 with wheel 200 and hub cap 300, both configured to be mounted to a hub 1 and axle 10 of vehicle 15. The wheel 200 includes a rim (or flange) section 210, central hub section 220 with lug-receiving holes 230 and central bore 240, and web (or spoke) section 250. Hub 1 includes holes therein (not shown) to allow threaded placement of lugs 20 which in turn allow threaded attachment of lug nuts 30. The corresponding holes 230 formed in wheel 200 allow placement of lugs 20 through the aligned holes, while accompanying lug nuts 30 secure the wheel 200 to the hub 1 through the lugs 20. A tire 50 is also mounted onto the rim section 210 of wheel 200.

In a preferred (although not necessary) embodiment, the hub cap 300 is made from a non-metallic material, such as plastic or related resin, examples of which may include acrylonitrile-butadiene-styrene (ABS), polycarbonate or a combination thereof. The material may further include continuous or discontinuous fiber reinforcements, such as glass, polymers, ceramics or the like. The hub cap 300 includes an outer surface 310 and inner surface 320. A body portion of hub cap 300 defines the general external configuration, while a wheel coupling portion, which cooperates with inner surface 320 and is discussed in more detail below, promotes secure connection between the hub cap 300, and the wheel 200 or the lug nuts 30, or both. In the present context, the outer surface of the hub cap 300 is that which is visible to an observer when the wheel 200 is mounted to an automobile or related vehicle and is covered by the hub cap 300. Accordingly, the outer surface 310 of hub cap 300 is configured to provide an aesthetically-pleasing cover for at least a portion of central hub section 220, and may (among other things) be metallized with an appropriate coating to define a chrome-like or related appearance. The inner surface 320 may or may not include a metallized coating, depending on the need or on the method of manufacture. For example, a metallized coating may or may not be placed on the inner surface 320, depending on whether the hub cap 300 is masked prior to coating deposition. In another variation on aesthetic enhancement, the hub cap may include molded-in coloring or have its outer surface painted.

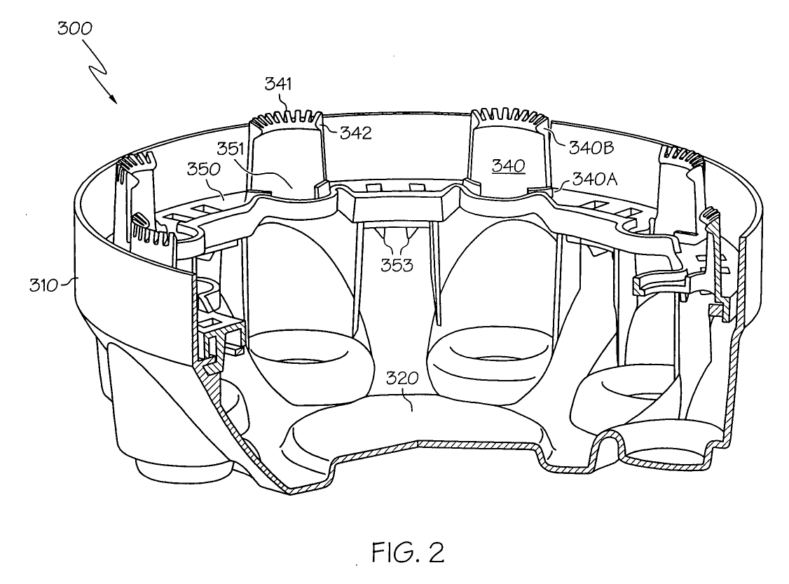

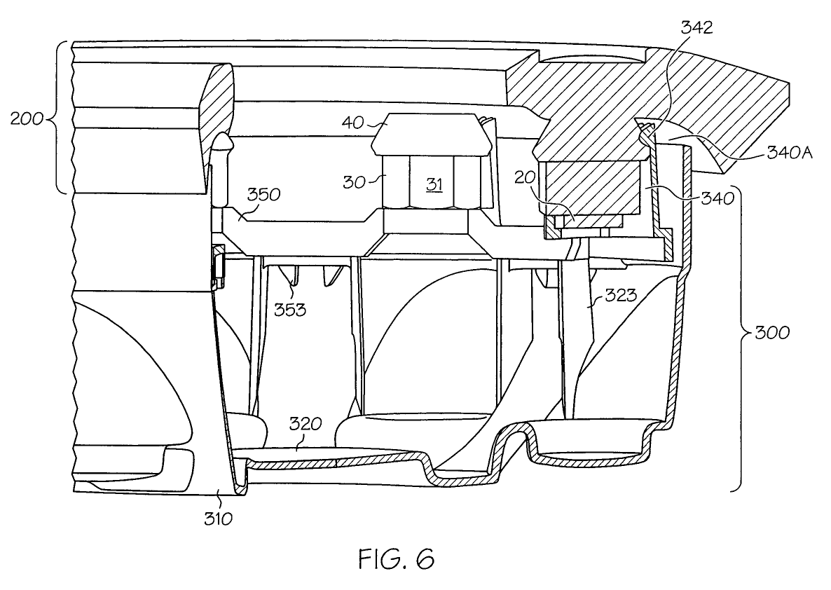

Referring next to FIGS. 2 through 5, views of the inner surface 320 of a two-piece embodiment of the hub cap 300 are shown. FIG. 6 depicts its attachment to the lug nuts 30 of wheel 200. FIG. 2 is a cutaway view that shows the cooperation of the inner surface 320 and a series of circumferentially-spaced lug nut engaging members 340 that are integrally formed at a proximal end base 340A on a lug nut engaging ring 350. The lug nut engaging members 340 each define an arcuate structure 341 that extends axially inward to a distal end crown 340B to affix the hub cap 300 to wheel 200 by engaging the lug nuts 30. By its arcuate shape, each lug nut engaging member 340 exhibits greater flexural rigidity than a generally planar member, yet is not so rigid that the lug nut engaging member 340 may not be flexed when pressed upon by a lug nut 30. As can be seen in the figures, the crown 340B of each lug nut engaging member 340 may define a castellated structure 341, and may further form a radially-projecting protrusion 342 that includes bevelling to facilitate engagement with a surface of lug nut 30. The castellated structure 341 enhances the flexibility of the member 340. The base 340A of each of the lug nut engaging members 340 surrounds a generally circular aperture 351 formed in the ring 350 through which at least a portion of one or both of the lug 20 and lug nut 30 are configured to pass. Resiliently-biased ring detents 353 are integrally formed on the ring 350 and spaced between adjacent lug nut engaging members 340. They extend axially outward from the opposite side of the ring 350 from which the lug nut engaging members 340 are disposed.

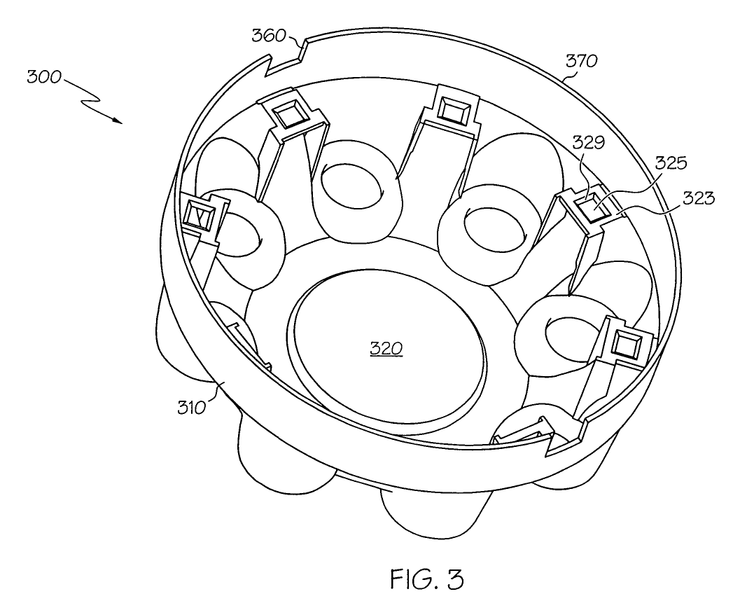

FIG. 3 highlights the rear (inward-facing) cutaway view of the inner surface 320, including a series of circumferentially-spaced bosses 323 defining rectangular mounting apertures 325. The axially inward-facing surface of the mounting apertures 325 are axially coplanar with one another, and include bevels or chamfers 329 to promote the insertion and cooperation of resiliently-biased ring detents 353. By integrally forming the bosses 323 into the inner surface 320 of the hub cap 300, complexity of the molds required to form the hub cap 300 is reduced, as all features can be formed in the line of the mold draw as the mold opens. Opposed slots 360 can be formed in the body portion of hub cap 300 to facilitate the insertion of a tool (for example, a screwdriver) with which to pry the hub cap 300 off a wheel 200. The lowermost edge 370 is generally planar so that when placed in contact with an adjoining surface of wheel 200, the hub cap 300 is properly oriented to avoid misalignment and concomitant hub cap wobble.

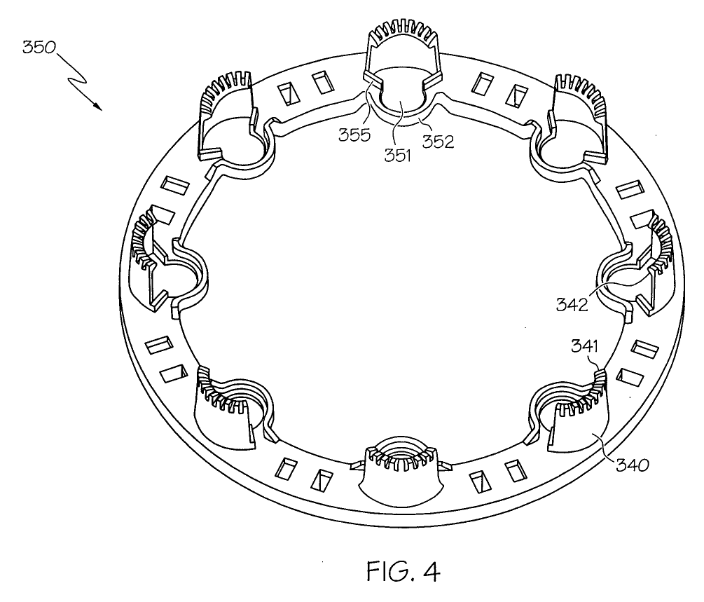

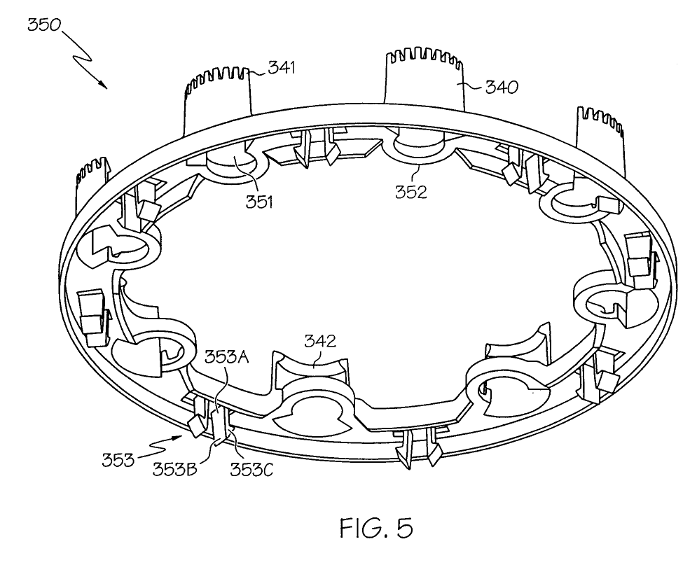

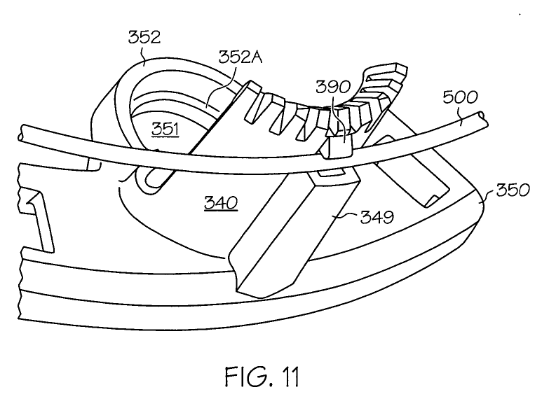

FIGS. 4 and 5 show the ring 350 from axially opposing sides. FIG. 4 shows the axially inward-facing side of ring 350, from which the circumferentially-spaced lug nut engaging members 340 extend. As can be seen, the lug nut engaging members 340 are integrally formed into ring 350. Apertures 351 are formed in the ring 350, and define a generally circular (or at least semicircular) shape. Semicircular horizontal ribs 352 extend radially inward from ring 350 and cooperate with base 340A of lug nut engaging member 340 to define a securing area for lug nut 30 and allow passage of lug 20. In addition, horizontal ribs 352 may form a tiered structure to permit the innermost surface of lug nut 30 to rest on a shelf 352A (shown with greater clarity in FIG. 11) while having portions of the lateral surface of lug nut 30 fit within the circumference partially defined by horizontal rib 352. Snap-fit detents (also referred to as tabs) 353 possess a resilient bias that is overcome when ring 350 is pushed into aperture 325 of boss 323 until the detents 353 snap into place. As shown in FIG. 5, the detents 353 include a proximal end 353A that is adjacent the ring 350 and a distal end 353B with pawls 353C or related accentuated heads that are configured to secure the detent 353 to the portion of the boss 323 that surrounds aperture 325. As stated earlier, the ring 350 can be made from a temperature-resistant material, such as a high-temperature plastic, ceramic or composite based on plastic or ceramic. One suitable material is a glass-reinforced nylon composite. Anti-rotation standoffs 355 are formed on either the ring 350 or the lug nut engaging members 340 to engage one or more of the faceted surfaces 31 of the lug nut 30 to inhibit its rotation.

FIG. 6 shows a cutaway view of the engagement of the hub cap 300 to the wheel 200 through the use of the ring 350, lug engaging members 340, lugs 20 and lug nuts 30. Ring 350 is secured to the hub cap 300 by the snap-fit detents 353 that extend through aperture 325 formed in boss 323 that is integrally formed into inner surface 320 of the body portion of hub cap 300. A bevelled connector 40 can be used to provide a secure mounting location for the distal end 340B and corresponding radially-projecting protrusion 342 of lug nut engaging member 340. The bevelled connector 40 can be either integrally formed with lug nut 30, or can form a separate piece.

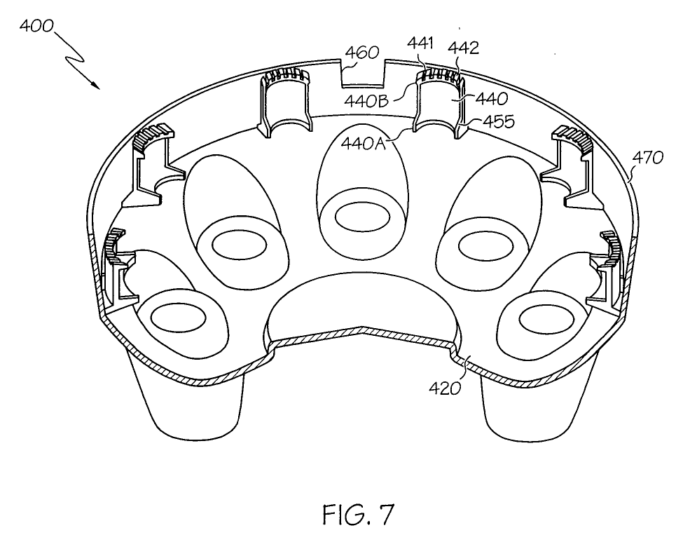

Referring next to FIG. 7, the inner surface 420 of a one-piece embodiment of the hub cap 400 is shown in cutaway view. Unlike the embodiment of FIGS. 2 through 6, this embodiment can be formed from a single molded part, as lug nut engaging members 440 are integrally formed into the inner surface 420. As with the previous embodiment lug nut engaging members 340, the lug nut engaging members 440 of FIG. 7 define an arcuate structure 441 that extends axially inward from a proximal base 440A to a distal end crown 440B. As discussed above, in situations requiring prolonged high-temperature durability, appropriate parts, may be made from materials (such as those previously discussed) specifically configured for elevated temperature environments. In the present embodiment, if such elevated temperature capability were required, the entire hub cap 400 could be formed from such a material.

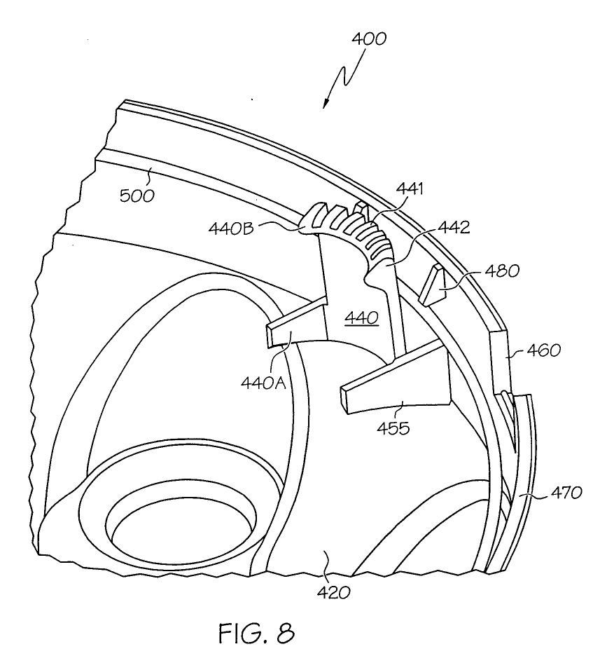

Referring next to FIG. 8, the use of a retaining wire 500 to provide additional radial support to lug nut engaging member 440 is shown. As previously mentioned, retaining wire 500 can be made of ceramics or high-temperature plastics (including fiber-reinforced composites thereof), metal or other high strength, heat-resistant material. Projections 480 built into the inner surface 420 of hub cap 400 can be arranged to ensure a frictional fit of retaining wire 500 during wheel operation. It will be appreciated by those skilled in the art that the retaining wire 500 is compatible with either the presently-shown one-piece hub cap 400 or the two-piece hub cap 300. FIG. 8 also illustrates a different configuration for the anti-rotation standoffs 455 that includes longer flat sides that can contact a larger portion of one of the faceted surfaces 31 of lug nut 30. As shown, standoff 455 can be integrally formed with the inner surface 420. It will be further appreciated by those skilled in the art that either of the anti-rotation standoffs 355 or 455 are equally useable with either the one-piece or two-piece hub cap configurations. Lug nut engaging member 440 may otherwise be similar to that shown previously, including having an arcuate crown 441. As with the two-piece configuration shown earlier, the present one-piece configuration has a generally planar lowermost edge 470 to properly seat hub cap 400 with an adjoining surface of wheel 200 to avoid misalignment and related wobble. In addition, slot 460 formed in the side of hub cap 400 is included facilitate separation of the hub cap 400 from the wheel 200.

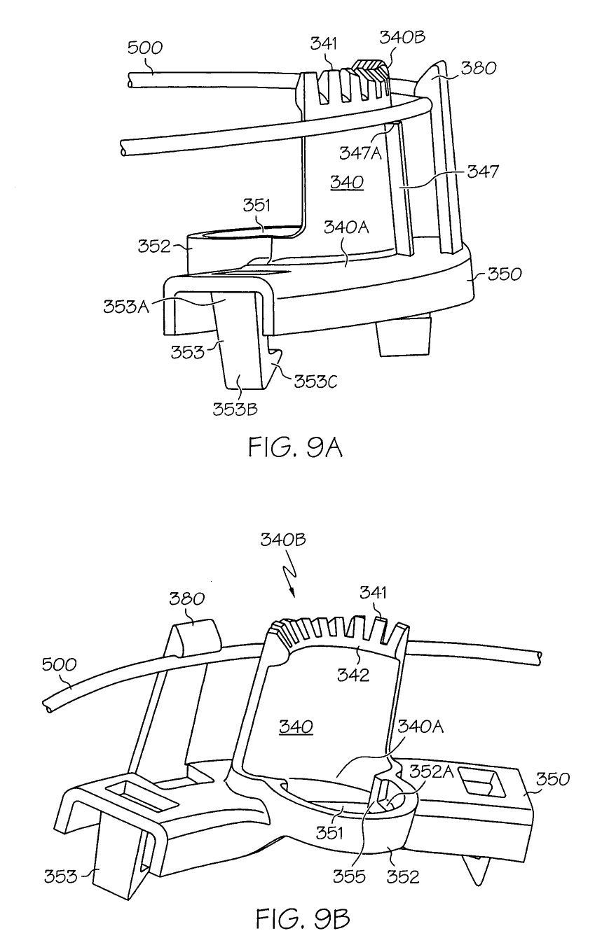

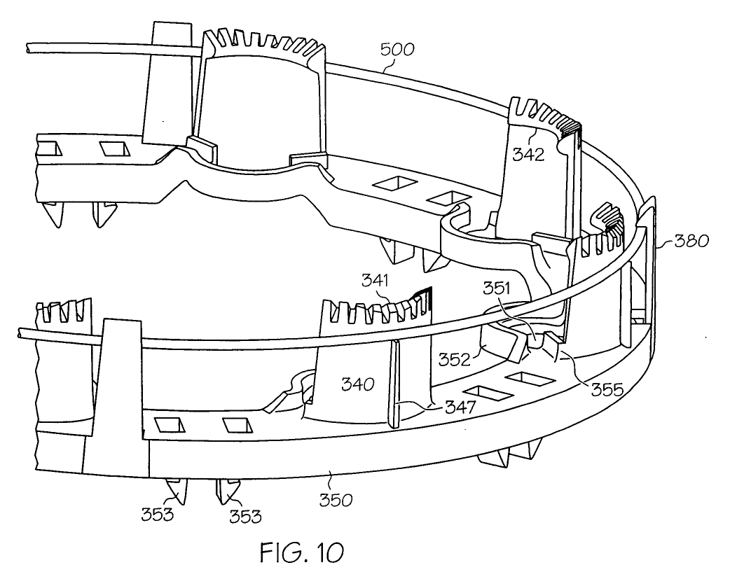

Referring next to FIGS. 9A through 11, cooperation of the retaining wire 500 with the lug nut engaging member 340 of ring 350 is shown. Each lug nut engaging member 340 may also include a stiffening rib 347 disposed longitudinally on the surface away from the side that engages the lug nut 30. In addition to providing enhanced flexural rigidity, it can include a ledge 347A to act as a contact point for retaining wire 500 to promote the aforementioned frictional fit. To that end, additional devices can be used, such as flexible retaining wire retention device 380 (shown with particularity in FIGS. 9A and 9B) to cooperate with ledge 347A or a projection similar to that depicted in FIG. 8. Referring with particularity to FIG. 11, an alternative attachment scheme for retaining wire 500 is shown. In it, stiffening rib 349 is affixed to or formed on the radially outward-facing surface of lug nut engaging member 340. To keep the ability of the lug nut engaging member 340 to flex, stiffening rib 349 could be affixed directly to ring 350 without contacting lug nut engaging member 340. The top of stiffening rib 349 serves as a lower mounting surface of the retaining wire 500, while a projection 390 forms an upper mounting surface to keep the retaining wire 500 in place. In one form, a tight friction fit may clamp the retaining wire 500 in place. Other equivalents to the ledge 347A and the upper surface of the stiffening rib 349 could also be employed to provide additional axial support to retaining wire 500. For example, a projection (not shown) could be integrally formed around the periphery of ring 350 and extend axially a distance sufficient to contact an opposite side of retaining wire 500 from that of projection 390.

Having described the invention in detail and by reference to preferred embodiments thereof, it will be apparent that modifications and variations are possible without departing from the scope of the invention defined in the appended claims.

What is claimed is:

1. A hub cap comprising:
a non-metallic body portion defining an inner surface and an outer surface; and
a non-metallic wheel coupling portion extending from said inner surface of said body portion, said wheel coupling portion comprising a plurality of circumferentially spaced and resiliently biased lug nut engaging members that are axially alignable with corresponding lug nuts disposed on a wheel, each of said lug nut engaging members comprising:
a substantially arcuate base configured to axially engage a corresponding one of said lug nuts; and
a substantially arcuate crown axially aligned with, and disposed axially inward relative to, said substantially arcuate base such that, upon engagement between said hub cap and said lug nuts, radial deflections imparted to each of said lug nut engaging members causes them to engage with said lug nuts, thereby keeping said hub cap attached to said wheel.

2. The hub cap of claim 1, wherein said lug nut engaging members further comprise a plurality of anti-rotation standoffs disposed about said substantially arcuate base, said anti-rotation standoffs configured to contact radial outward surfaces of said lug nuts.

3. The hub cap of claim 1, wherein said plurality of lug nut engaging members are integrally formed with said body portion.

4. The hub cap of claim 3, wherein each of said lug nut engaging members forms a substantially cantilevered attachment to said body portion such that said substantially arcuate base defines a proximal end and said substantially arcuate crown defines a distal end that moves radially relative to said proximal end and said body portion.

5. The hub cap of claim 4, wherein each of said lug nut engaging members further comprise an axial stiffening rib formed on a surface thereof to enhance resistance to said radial deflection.

6. The hub cap of claim 5, wherein said substantially arcuate crown defines a castellated structure along an axial inward surface thereof.

7. The hub cap of claim 1, wherein said lug nut engaging members are integrally formed with one another on a common ring, said ring being removably attachable to said body portion through an aperture defined in a boss formed on said inner surface.

8. The hub cap of claim 7, wherein said ring comprises a plurality of projections configured to engage said boss aperture.

9. The hub cap of claim 8, wherein said plurality of projections comprise snap-fit detents that are integrally formed in said ring.

10. The hub cap of claim 1, further comprising a metallic coating disposed on at least an outer surface of said body portion.

11. The hub cap of claim 1, wherein at least one of said non-metallic body or wheel coupling portions is made of a plastic material.

12. The hub cap of claim 1, wherein at least one of said non-metallic body or wheel coupling portions is made of a composite.

13. The hub cap of claim 1, wherein said substantially arcuate base and said substantially arcuate crown define a radially outward portion of each of said lug nut engaging members.

14. The hub cap of claim 13, further comprising a retaining wire disposed on a radially outward-facing surface of said lug nut engaging members.

15. A hub cap comprising:
a non-metallic body portion defining an inner surface and an outer surface, said inner surface comprising a boss with an aperture formed therein; and
a non-metallic wheel coupling portion removably attachable to said body portion, said wheel coupling portion comprising:
a ring;
a plurality of circumferentially spaced and resiliently biased lug nut engaging members disposed on said ring, said lug nut engaging members extending axially inward and alignable with corresponding lug nuts disposed on a wheel, each of said lug nut engaging members comprising:
a proximal end defining a base configured to axially engage a corresponding one of said lug nuts; and
a distal end defining a substantially arcuate crown axially aligned with and disposed axially inward relative to said base such that, upon engagement between said hub cap and said lug nuts, radial deflections imparted to said substantially arcuate crown causes said crown to cooperate with said lug nut, thereby keeping said hub cap attached to said wheel; and
a plurality of projections disposed on said ring, said projections configured to engage said boss aperture to facilitate connection between said wheel coupling portion and said body portion.

16. The hub cap of claim 15, wherein said projections comprise snap-fit detents.

17. The hub cap of claim 16, wherein said snap-fit detents comprise an angled distal portion and said boss aperture defines a beveled surface to facilitate the insertion of said angled distal portion of snap-fit detents therein.

18. The hub cap of claim 15, wherein said lug nut engaging members and said projections are integrally formed with said ring.

19. The hub cap of claim 18, wherein said ring, lug nut engaging members and projections are made from a material selected from the group consisting of plastics, ceramics, composites or combinations thereof.

20. A wheel assembly comprising:
a wheel; and
a hub cap configured to cover at least a portion of said wheel, said hub cap comprising:
a non-metallic body portion defining an inner surface and an outer surface; and
a non-metallic wheel coupling portion extending from said inner surface of said body portion, said wheel coupling portion comprising a plurality of circumferentially spaced and resiliently biased lug nut engaging members that are axially alignable with corresponding lug nuts that are configured to secure said wheel to a vehicle, each of said lug nut engaging members comprising:
a substantially arcuate base configured to axially engage a corresponding one of said lug nuts; and
a substantially arcuate crown axially aligned with and disposed axially inward relative to said substantially arcuate base such that, upon engagement between said hub cap and said lug nuts, radial deflections imparted to each of said lug nut engaging members causes them to cooperate with said lug nuts, thereby keeping said hub cap attached to said wheel.

21. The wheel assembly of claim 20, wherein said plurality of lug nut engaging members are integrally formed with said body portion.

22. The wheel assembly of claim 20, wherein said lug nut engaging members are integrally formed with one another on a common ring, said ring comprising a plurality of snap-fit detents that make said ring removably attachable to said body portion by engaging said snap-fit detents through an aperture defined in a boss formed on said inner surface.

23. A method of covering a vehicular wheel, said method comprising:
providing a wheel with an inner surface, an outer surface and a plurality of lug nuts substantially protruding from said wheel outer surface;
providing a hub cap, said hub cap comprising:
a non-metallic body portion defining an inner surface and an outer surface; and
a non-metallic wheel coupling portion extending from said inner surface of said body portion, said wheel coupling portion comprising a plurality of circumferentially spaced and resiliently biased lug nut engaging members, each axially alignable with a corresponding one of said lug nuts, each of said lug nut engaging members comprising:
a base configured to axially engage a corresponding one of said lug nuts; and
a substantially arcuate crown axially aligned with and disposed axially inward relative to said base; and
securing said hub cap to said wheel such that said lug nuts impart a radial deflection to each corresponding said lug nut engaging members, thereby causing them to keep said hub cap attached to said wheel.

24. The method of claim 23, wherein said securing further comprises:
configuring said wheel coupling portion as a ring with said lug nut engaging members extending therefrom; and
creating a snap-fit connection between said ring and said body portion to facilitate removable attachment therebetween.

25. The method of claim 24, wherein at least one of said body portion and said ring comprises a material selected from the group consisting of plastics, ceramics, composites or combinations thereof.

26. The method of claim 23, further comprising covering at least a portion of said outer surface of said body portion with a metallic coating.

27. The method of claim 23, further comprising reinforcing said lug nut engaging members with a retaining wire.
